(19) United States
(12) Patent Application Publication
(10) Pub. No.: US 2018/0184678 A1
(43) Pub. Date: Jul. 5, 2018

(54) PULVERULENT EMULSIFIED COMPOSITION

(71) Applicant: FUJI OIL HOLDINGS INC., Osaka (JP)

(72) Inventors: Takayasu MOTOYAMA, Sakai-shi, Osaka (JP); Atsuya KATSURA, Izumisano-shi, Osaka (JP); Takashi ICHINOSE, Moriya-shi, Ibaraki (JP)

(73) Assignee: FUJI OIL HOLDINGS INC., Osaka (JP)

(21) Appl. No.: 15/740,418

(22) PCT Filed: Jul. 13, 2016
(86) PCT No.: PCT/JP2016/070685

§ 371 Date: Dec. 28, 2017

(30) Foreign Application Priority Data
Jul. 14, 2015 (JP) 2015-140105

(51) Int. Cl. A23C 11/10; A23J 3/16; A23J 3/04; A23P 10/47

(52) U.S. Cl. CPC A23C 11/103; A23J 3/16; A23J 3/04; A23P 10/47; A23V 2300/26; A23V 2200/212; A23V 2200/222; A23V 2250/046; A23V 2300/10; A23V 2002/00

(57) ABSTRACT

The purpose of the present invention is to provide a pulverulent emulsified composition in which a soybean protein material is used as a protein material constituting part of the pulverulent emulsified composition, the pulverulent emulsifier composition having excellent color tone and exhibiting no feathering or oiling-off when added to, e.g., coffee. A pulverulent emulsified composition that contains, in proportion by dry weight, 0.3-7.0% by weight of a soybean protein material, 10-40% by weight of oils/fats, 0.01 to less than 1.0% by weight of a buffer salt, 40-70% by weight of sugars, and 0.8-5.0% by weight of an emulsifier, and is characterized in that when 5 g thereof is dispersed into coffee obtained by dissolving 2 g of instant coffee in 150 mL of 80° C. water, the lightness (L* value) of the dispersion is at least 35, makes it possible to obtain excellent color tone and exhibits no feathering or oiling-off when added to coffee.

### TECHNICAL FIELD

The present invention relates to a powdered emulsified composition.

### BACKGROUND ART

Sodium caseinate has been used for a powdered coffee whitener which is added to coffee for imparting mild feeling because sodium caseinate does not impair the coffee flavor, shows good emulsion stability, and well disperses in the coffee. However, in recent years, a demand of instant non-dairy creamer powder (ICP) containing much amount of vegetable ingredients is increasing, as a substitute for a sodium caseinate, which is a raw material of whitener, and whose demand is globally increasing, and from a trend of avoiding animal ingredients causing health problems such as accumulation of cholesterol.

Up to now, powdered coffee whitener containing soybean protein composition has been tried to manufacture. However, powdered coffee whitener containing about 30% by weight of soybean protein composition relative to protein in the powdered coffee whitener causes feathering when added to coffee and cannot be used as a coffee whitener. Patent Document 1 discloses that a combination of soybean protein isolate and sodium caseinate reduces feathering when added to coffee. However, a coffee whitener containing only soybean protein composition has not yet produced.

In Patent Documents 2 and 3, a whitener made from soymilk as a soybean protein composition is tried to produce. However, Patent Document 2 does not describe a whitener containing only soymilk, but describes a combination with sodium caseinate. Patent Document 3 has proposed a whitener containing soymilk only. However, the whitener disclosed in Patent Document 3 destroys an original flavor of coffee by soymilk flavor. Thus, Patent Document 3 cannot provide a coffee whitener which can substitute sodium caseinate.

Furthermore, in Patent Document 4, a whitener is tried to produce by adding soybean protein isolate. However, Patent Document 4 does not consider a sterilization step which is necessarily carried out in the production of whitener. In addition, the obtained whitener shows weak whitening effect although a coffee whitener requires whitening effect when added to coffee. Thus, the whitener disclosed in Patent Document 4 is insufficient for substituting a whitener containing sodium caseinate.

### PRIOR ART DOCUMENTS

### Patent Documents

Patent Document 1: WO 2009/084529 A

Patent Document 2: JP 2009-232754 A

Patent Document 3: JP 2006-158295 A

Patent Document 4: JP H06-303901 A

### SUMMARY OF INVENTION

### Problems to be Solved by Invention

An object of the present invention is to provide a powdered emulsified composition prepared by using a soybean protein material as a protein material constituting the powdered emulsified composition, where the composition, for example, has good color and does not cause feathering and oil-off when the composition is added to coffee.

### Means for Solving Problems

The inventors have extensively studied for solving the above problems. As a result, they have found that a powdered emulsified composition including, in terms of dry basis, 0.3 to 7.0% by weight of soybean protein material, 10 to 40% by weight of fat, less than 1.0% by weight of buffer salt, 40 to 70% by weight of sugar, and 0.8 to 5.0% by weight of emulsifier, where the composition provides 35 or more of lightness (L* value) when 5 g of the composition is dispersed into a coffee prepared by dissolving 2 g of instant coffee into 150 ml of water at 80° C., has good color and does not cause feathering and oil-off when the composition is added to coffee. The present invention has been completed based on the finding.

That is, the present invention is:

(1) A powdered emulsified composition including, in terms of dry basis, 0.3 to 7.0% by weight of soybean protein material, 10 to 40% by weight of fat, 0.01% by weight or more and less than 1.0% by weight of buffer salt, 40 to 70% by weight of sugar, and 0.8 to 5.0% by weight of emulsifier, where the composition provides 35 or more of lightness (L* value) when 5 g of the composition is dispersed into a coffee prepared by dissolving 2 g of instant coffee into 150 ml of water at 80° C.;

(2) The powdered emulsified composition of (1), where the composition contains, in terms of dry basis, 0.01% by weight to 0.5% by weight of buffer salt; and

(3) A process for producing a powdered emulsified composition including: mixing a soybean protein material, a buffer salt, a sugar, and an emulsifier in an aqueous system; adding a fat to the mixture and homogenizing the obtained mixture to obtain an oil-in-water emulsion composition; sterilizing the oil-in-water emulsion composition at 110 to 150° C. for 1 to 10 seconds; and then drying the composition, where the powdered emulsified composition contains, in terms of dry basis, 0.3 to 7.0% by weight of soybean protein material, 10 to 40% by weight of fat, 0.01% by weight or more and less than 1.0% by weight of buffer salt, 40 to 70% by weight of sugar, and 0.8 to 5.0% by weight of emulsifier.

### Effects of Invention

The present invention enables to obtain a powdered emulsified composition, for example, showing good whitening effect and not causing feathering and oil-off when the composition is added to coffee.

### MODE FOR CARRYING OUT INVENTION

Hereinafter, the present invention will be specifically described.

### (Powdered Emulsified Composition)

A powdered emulsified composition of the present invention contains, in terms of dry basis, 0.3 to 7.0% by weight of soybean protein material, 10 to 40% by weight of fat, 0.01% by weight or more and less than 1.0% by weight of buffer salt, 40 to 70% by weight of sugar, and 0.8 to 5.0% by weight of emulsifier. The powdered emulsified composition of the present invention, for example, does not cause feathering and oil-off when added to coffee. Further, the composition shows excellent whitening effect. More specifically, the composition enables to impart high whitening effect, such as 35 or more of lightness (L* value) when 5 g of the composition is dispersed into a coffee prepared by dissolving 2 g of instant coffee into 150 ml of water at 80° C.

### (Soybean Protein Material)

Examples of soybean protein material in the present invention include soybean protein isolate, alkaline earth metal binding-soybean protein isolate, soybean protein concentrate, whole soymilk, whole soymilk powder, defatted soymilk, defatted soymilk powder, alkaline earth metal binding-defatted soymilk or defatted soymilk powder, and sugar-containing soybean protein.

In one aspect, in the case of using soybean protein isolate, soybean protein material having high crude protein content with respect to the total solid content, for example, 80% by weight or more, preferably 85% by weight or more, more preferably 90% by weight or more, may be used. In this case, it may be preferable to use the soybean protein material having high crude protein content.

Meanwhile, in some cases, such as sugar-containing soybean protein and soymilk powder, it may be preferable to use a soybean protein material having lower crude protein content.

In another aspect, an enzyme-degraded soybean protein material may be used. In some cases, it may be preferable to use the enzyme-degraded soybean protein material. In the case of using the enzyme-degraded soybean protein material, for example, a soybean protein material enzymatically degraded until 0.22M trichloroacetic acid (TCA) soluble protein rate of the material is preferably 3 to 50% by weight, more preferably 10 to 35% by weight, further preferably 15 to 30% by weight, may be used.

For example, in the case of using a sugar-containing soybean protein, sugar may be added with consideration of the amount of sugar contained in the soybean protein so that the content of sugar in the powdered whitener falls within the intended amount.

From the viewpoints of using vegetable soybean protein material as protein to be used in the powdered emulsified composition of the present invention and adding a large amount of vegetable raw material, amount of animal protein such as sodium caseinate is preferably less than that of soybean protein. For example, a ratio of solid content of animal protein to a solid content of soybean protein material is preferably 20% by weight or less, more preferably 10% by weight or less, most preferably 0% by weight.

An adding amount of soybean protein material with respect to an amount of powdered emulsified composition in terms of dry basis is 0.3 to 7.0% by weight. When the adding amount of soybean protein material with respect to the amount of powdered emulsified composition in terms of dry basis is less than 0.3% by weight, for example, an emulsion stability of the coffee whitener may deteriorate and the viscosity may be rapidly increased to occur high-consistency state called “bote”. In addition, when the adding amount of soybean protein material with respect to the amount of powdered emulsified composition in terms of dry basis is more than 7.0% by weight, feathering may be occurred when the composition is added to coffee.

### (Fat)

As a fat used in the present invention, any fat including animal fat and vegetable fat may be used. Examples of the vegetable fat include soybean oil, rapeseed oil, palm oil, palm kernel oil, and sunflower oil. Examples of the animal fat include milk fat, fish oil, and lard. These fats may be used alone or in combination of more than one fat.

When it is better to avoid animal raw materials due to health problems such as cholesterol accumulation, it is preferable to use a vegetable fat.

An adding amount of fat with respect to an amount of powdered emulsified composition in terms of dry basis is 10 to 40% by weight. When the adding amount of fat is less than 10% by weight in terms of dry basis, the whitener may not be successfully emulsified and dispersed in coffee when the composition is added to coffee. And, when the adding amount of fat is more than 40% by weight in terms of dry basis, an emulsion stability of the whitener may deteriorate.

### (Buffer Salt)

A buffer salt includes phosphate, and citrate. Examples of the phosphate include hexametaphosphate, sodium hydrogen phosphate, potassium hydrogen phosphate, and sodium polyphosphate. Further, examples of the citrate include disodium citrate, dipotassium citrate, trisodium citrate, and tripotassium citrate.

It is preferable to use phosphate as a buffer salt.

An adding amount of buffer salt in terms of dry basis is 0.01% by weight or more and less than 1.0% by weight. When the adding amount is more than 1.0% by weight, the whitener containing soybean protein material as a major component may show remarkably increased viscosity in the liquid preparation step unlike a whitener containing sodium caseinate as a major component, and thereby, may not be successfully dispersed in coffee and may cause feathering and oil-off when the composition is added to coffee. And, when the adding amount of buffer salt is less than 0.01% by weight in terms of dry basis, an effect of the present invention may reduce. For example, the adding amount in terms of dry basis is preferably 0.01% by weight to 0.5% by weight, more preferably 0.05% by weight to 0.5% by weight.

### (Sugar)

Examples of sugar include sucrose, fructose, glucose, starch syrup, reducing starch syrup, honey, isomerized sugar, invert sugar, oligosaccharides such as isomalto-oligosaccharide, reducing xylo-oligosaccharide, reducing gentio-oligosaccharide, xylo-oligosaccharide, gentio-oligosaccharide, nigero-oligosaccharide, Theande-origosaccharide, and soybean oligosaccharide, trehalose, sugar alcohol, such as maltitol, erythritol, sorbitol, palatinit, xylitol, and lactitol, and glucosyl sucrose syrup (coupling sugar).

An adding amount of sugar with respect to an amount of powdered emulsified composition in terms of dry basis is 40 to 70% by weight. When the adding amount of sugar in terms of dry basis is less than 40% by weight, whitening effect may reduce when the composition is added to coffee. In addition, when the adding amount of sugar in terms of dry basis is more than 70% by weight, fat content in the formulation becomes low and thereby whitening effect may also reduce when the composition is added to coffee.

A content of sugar is determined by carbohydrate content of a powdered emulsified composition. When a sugar-containing soybean protein material is used, the content of sugar, including the amount of sugar (carbohydrate) in the sugar-containing protein material, is calculated.

A ratio of soybean protein material to sugar to be used in a powdered emulsified composition is preferably soybean protein material:sugar=1:7 to 60, more preferably 1:8 to 40, more preferably from 1:10 to 30 in a weight ratio. Such a range of the ratio of soybean protein material to sugar may enhance the whitening effect.

### (Emulsifier)

Examples of emulsifier include monoglycerol fatty acid ester, polyglycerol fatty acid esters, sucrose fatty acid esters, organic acid monoglyceride, polysorbate, and lecithin. These emulsifiers may be used alone or in combination of more than one emulsifier. When an emulsifier having 12 or more of HLB is used, stability of the whitener is improved and an occurrence of feathering and oil-off may be suppressed. In particular, when a sugar ester having 12 or more of HLB is used in combination with an organic acid monoglycerides having 7 or more of HLB, an emulsion stability of coffee whitener is more improved, a formation of aggregates is further suppressed, and a rapid increase in viscosity of the whitener in the liquid preparation step may be avoided.

An adding amount of emulsifier with respect to an amount of powdered emulsified composition in terms of dry basis is 0.8 to 5.0% by weight. When the adding amount of emulsifier in terms of dry basis is less than 0.8% by weight, an emulsion stability of coffee whitener may be low and aggregation may be formed when the composition is added to coffee. In addition, when the adding amount of sugar in terms of dry basis is more than 5.0% by weight, a taste of emulsifier may be strong and a flavor of coffee may deteriorate.

### (Sweetener)

Sweetener component which is well-known or will be known in future may also be added to the powdered emulsified composition of the present invention. More specifically, sweetener such as aspartame, acesulfame potassium, sucralose, alitame, neotame, licorice extract (glycyrrhizin), saccharine, saccharine sodium, and stevia extract may be used.

### (Preparation of Powdered Emulsified Composition)

In order to prepare a powdered emulsified composition, a soybean protein material, a buffer salt, a sugar, and an emulsifier are mixed in an aqueous system, and then the mixture is mixed with a fat and homogenized. The homogenization is to miniaturize droplets of oil-in-water emulsion composition after preparing the oil-in-water emulsion composition from a mixture of oil and water. One example of miniaturization is a method of using an apparatus such as an emulsification equipment. Examples of the emulsification equipment include stirrer having rotating impeller, colloid mill having disk or rotor rotating at high speed and fixed disk, ultrasonic emulsifier, and homogenizer which is one type of high pressure pump. Among them, homogenizer is preferable. For example, homogenization is carried out by homogenizing an oil-in-water emulsion composition containing the above raw materials with a homogenizer at a pressure of 30 to 200 kg/cm², then sterilizing at 110 to 150° C., preferably 120 to 140° C., for 1 to 10 seconds, preferably 3 to 7 seconds, and then further homogenizing at a pressure of 150 to 500 kg/cm² with a homogenizer. A powdered emulsified composition is obtained by cooling the homogenized oil-in-water emulsion composition, and then spray-drying.

A powdered emulsified composition obtained by the above method has good whitening effect, and thus a coffee showing good color tone may be obtained, typically, by adding the composition to coffee.

In the present invention, a whitening effect of powdered emulsified composition is evaluated by measuring color tone of an instant coffee.

More specifically, 2 g of instant coffee (Nescafe Gold Blend: manufactured by Nestle corporation) is dispersed into 150 ml of hot water at 80° C. to prepare a coffee, and then 5 g of powdered emulsified composition is added and dispersed into the coffee. This coffee is cooled to 25° C. and measured by colorimeter (Color meter ZE6000: manufactured by Nippon Denshoku Industries Co., Ltd.).

When L* value is 35 or more, it is assumed that whitening effect is high and good. It is preferable that L* value is 37 or more, more preferably 40 or more.

The powdered emulsified composition obtained by the above method may be applied to various foods because the composition shows good emulsion stability and color tone. The powdered emulsified composition may be applied to various form of foods such as non-dairy creamer, thick liquid food, oil-in-water emulsion, water-in-oil emulsion, margarine, emulsified seasoning, dessert, confectionery, nutritional supplement, and beverage. Further, a powdered emulsified composition may also be used as a coffee whitener by making it liquid form.

Among them, the powdered emulsified composition of the present invention is particularly suitable for non-dairy creamer because it shows an excellent whitening effect without causing feathering and oil-off.

### EXAMPLES

Examples of the present invention will be explained in more detail herein below. However, the present invention is not limited to the following Examples. In the Examples, % means weight basis.

### Examples 1 to 5

According to the formulation of table 1, dipotassium phosphate, soybean protein isolate (Fujipro-CLE, crude protein content (solid basis): 91.3%, carbohydrate content (solids basis): 3.7%, 0.22M trichloroacetic acid (TCA) soluble protein rate: 24%, manufactured by Fuji Oil Co., Ltd.), emulsifier, and sugar (High Fructo M75C (solids content: 75%, manufactured by Japan corn starch Co., Ltd.) were added to water and stirred to dissolve while heating water at 70° C. Further, fat (hydrogenated rapeseed oil, manufactured by Fuji Oil Co., Ltd.) heated to 80° C. was added to the mixture and the mixture was further stirred. The mixture was then homogenized at a pressure of 30 to 150 kg/cm² with a high-pressure homogenizer, and then sterilized at 121° C. for 3 seconds. The value of raw materials other than water in table 1 was calculated as dry weight, each amount of moisture in the raw materials other than water was added to the amount of water.

Each oil-in-water emulsion which was sterilized was further homogenized at a pressure of 200 to 500 kg/cm² with a high pressure homogenizer, and then cooled and spray-dried to obtain powdered emulsified composition of each Example.

### Comparative Examples 1 to 3

According to the formulation of table 1, powdered emulsified composition of each Comparative Example was obtained in the same steps as the above Example.

TABLE 1

| | | Formulation | | | | | | | |
|---|---|---|---|---|---|---|---|---|---|
| | | | | | | | | Total | |
| | | Protein | | | | | | solid | |
| | | material | Sugar | Fat | Emulsifier | Phosphate | Water | content | Total |
| | | % by | % by | % by | % by | % by | % by | % by | % by |
| | | weight | weight | weight | weight | weight | weight | weight | weight |
| Examples | 1 | 2 | 30 | 15 | 1.2 | 0.5 | 51.30 | 48.70 | 100 |
| | 2 | 2 | 20 | 15 | 1.2 | 0.5 | 61.30 | 38.70 | 100 |
| | 3 | 2 | 30 | 20 | 1.2 | 0.5 | 46.30 | 53.70 | 100 |
| | 4 | 2 | 30 | 15 | 1.2 | 0.25 | 51.55 | 48.45 | 100 |
| | 5 | 2 | 30 | 15 | 1.2 | 0.05 | 51.75 | 48.25 | 100 |
| Comparative | 1 | 2 | 0 | 15 | 1.2 | 0.5 | 81.30 | 18.70 | 100 |
| Examples | 2 | 2 | 10 | 15 | 1.2 | 0.5 | 71.30 | 28.70 | 100 |
| | 3 | 2 | 30 | 15 | 1.2 | 1 | 50.80 | 49.20 | 100 |

### Evaluation Method of Powdered Emulsified Composition

### <Evaluation of Feathering and Oil-Off>

To 150 ml of hot water (80° C.), 2 g of commercially available instant coffee (Nescafe Gold Blend, manufactured by Nestle Co., Ltd.) was dissolved. To the coffee, 5 g of prepared powdered emulsified composition was added. After 30 seconds, coffee was stirred and feathering and oil-off were visually observed. In the table, “−” means “none”, “±” means “small amount”, and “+” means “large amount”.

Oil-off was similarly observed and described in the table that “−” means “none”, “±” means “small amount”, and “+” means “large amount”.

In either case, “−” or “±” by the visual observation was evaluated as acceptable.

### <Viscosity of Powdered Emulsified Composition in Liquid Production Step and Emulsified Particle Diameter>

A viscosity of powdered emulsified composition in liquid production step was measured with a B type viscometer (manufactured by TOKIMEC Inc.) at 25° C.

### <Emulsified Particle Diameter>

Emulsified particle diameter of the powdered emulsified composition in the liquid preparation step and after added to coffee was measured with a laser particle size analyzer (manufactured by Shimadzu Corporation).

### <Evaluation of Color Tone>

Measurement of color tone was carried out for each sample prepared in the feathering evaluation. Color tone was measured with a colorimeter (Color meter ZE6000 manufactured by Nippon Denshoku Industries Co., Ltd.) as L* value (JIS Z 8729).

L* value of 35 or more was evaluated as acceptable.

When the above evaluations of feathering, oil-off and color tone were all acceptable, the quality of the composition was acceptable and overall evaluation was “◯”. When at least one of the above evaluations of feathering, oil-off and color tone was unacceptable, the quality of the composition was unacceptable and overall evaluation was “Δ” or “×”.

The obtained evaluation results of each of Examples and Comparative Examples were summarized in table 2. Comparative Example 1 prepared in the same formulation described in Patent Document 4 did not occur feathering and oil-off after added to coffee, but color tone of the coffee was very dark as 21 of L* value as shown in the table. In Example 1 prepared by further adding 30% by weight of sugar in the formulation of Comparative Example 1, particle diameter of the powdered emulsified composition itself became small and L* value after added to coffee was high as 35 or more. This color tone was comparable in brightness as compared with commercially available products containing sodium caseinate. Example 2 having reduced sugar content showed slightly lowered L* value but maintained 35 or more and had good quality. However, Comparative Example 2 having 10% by weight of sugar content showed less than 35 of L* value and had unacceptable quality.

As a result of evaluating an effect of added phosphate, it was confirmed that 0.5% by weight or less in the formulation may be preferred as a powdered emulsified composition as shown in the results of Examples 3 to 5 and Comparative Example 3. Although sodium caseinate has high mineral resistance and phosphate is not a problem, soybean protein isolate shows reactivity to phosphate.

TABLE 2

| | | Evaluation in liquid | | | | | | |
|---|---|---|---|---|---|---|---|---|
| | | production step of | | | | | | |
| | | powdered emulsified | | | | | | |
| | | composition | | Evaluation after added to coffee | | | | |
| | | Particle | | | | Particle | | |
| | | diameter | Viscosity | | | diameter | L* | Overall |
| | Unit | μm | mPa · s | Feathering | Oil-off | μm | value | evaluation |
| Examples | 1 | 1.1 | 47.5 | − | − | 2.07 | 40.6 | ∘ |
| | 2 | 1.1 | 32.5 | − | − | 3.00 | 35.7 | ∘ |
| | 3 | 1.7 | 73.9 | − | − | 2.44 | 39.6 | ∘ |
| | 4 | 1.9 | 57.0 | − | − | 2.56 | 39.6 | ∘ |
| | 5 | 2.8 | 33.0 | − | − | 2.94 | 37.9 | ∘ |
| Comparative | 1 | 1.8 | 40.0 | − | − | 2.33 | 28.8 | x |
| Examples | 2 | 1.3 | 30.0 | − | − | 4.40 | 30.6 | Δ |
| | 3 | 2.0 | 75.0 | + | + | 4.40 | 38.7 | x |

1. A powdered emulsified composition comprising, in terms of dry basis, 0.3 to 7.0% by weight of soybean protein material, 10 to 40% by weight of fat, 0.01% by weight or more and less than 1.0% by weight of buffer salt, 40 to 70% by weight of sugar, and 0.8 to 5.0% by weight of emulsifier, wherein the composition provides 35 or more of lightness (L* value) when 5 g of the composition is dispersed into a coffee prepared by dissolving 2 g of instant coffee into 150 ml of water at 80° C.

2. The powdered emulsified composition according to claim 1, wherein the composition comprises 0.01% by weight to 0.5% by weight of buffer salt.

3. The powdered emulsified composition according to claim 1, wherein the composition provides 37 or more of lightness (L* value) when 5 g of the composition is dispersed into a coffee prepared by dissolving 2 g of instant coffee into 150 ml of water at 80° C.

4. The powdered emulsified composition according to claim 1, wherein the buffer salt is phosphate.

5. The powdered emulsified composition according to claim 1, wherein a ratio of solid content of animal protein to solid content of the soybean protein material is 20% by weight or less.

6. The powdered emulsified composition according to claim 1, wherein a ratio of solid content of animal protein to solid content of the soybean protein material is 10% by weight or less.

7. The powdered emulsified composition according to claim 1, wherein a ratio of solid content of animal protein to solid content of the soybean protein material is 0% by weight.

8. A process for producing a powdered emulsified composition comprising: mixing a soybean protein material, a buffer salt, a sugar, and an emulsifier in an aqueous system; adding a fat to the mixture and homogenizing the obtained mixture to obtain an oil-in-water emulsion composition; sterilizing the oil-in-water emulsion composition at 110 to 150° C. for 1 to 10 seconds; and then drying the composition, wherein the powdered emulsified composition comprises, in terms of dry basis, 0.3 to 7.0% by weight of soybean protein material, 10 to 40% by weight of fat, 0.01% by weight or more and less than 1.0% by weight of buffer salt, 40 to 70% by weight of sugar, and 0.8 to 5.0% by weight of emulsifier.

9. The process for producing a powdered emulsified composition according to claim 8, wherein the composition comprises 0.01% by weight to 0.5% by weight of buffer salt.

10. The process for producing a powdered emulsified composition according to claim 8, wherein the buffer salt is phosphate.

11. The process for producing a powdered emulsified composition according to claim 8, wherein a ratio of solid content of animal protein to solid content of the soybean protein material is 20% by weight or less.

12. The process for producing a powdered emulsified composition according to claim 8, wherein a ratio of solid content of animal protein to solid content of the soybean protein material is 10% by weight or less.

13. The process for producing a powdered emulsified composition according to claim 8, wherein a ratio of solid content of animal protein to solid content of the soybean protein material is 0% by weight.
